(19) United States
(12) Patent Application Publication
(10) Pub. No.: US 2025/0269799 A1
(43) Pub. Date: Aug. 28, 2025

(54) EXTENDABLE SUB-FLOOR STORAGE COVER

(71) Applicant: Rivian IP Holdings, LLC, Irvine, CA (US)

(72) Inventors: Miguel Angel RAMIREZ BASILIO, Aliso Viejo, CA (US); Mark Lennard TAYLOR, Laguna Beach, CA (US); Bryan Scott SHAMASKO, Irvine, CA (US); James John Alexander DOWLE, Laguna Beach, CA (US)

(21) Appl. No.: 19/051,465

(22) Filed: Feb. 12, 2025

Related U.S. Application Data
(60) Provisional application No. 63/559,086, filed on Feb. 28, 2024.

(51) Int. Cl. B60R 5/04; B60R 11/00

(52) U.S. Cl. CPC B60R 5/045; B60R 2011/0036

(57) ABSTRACT

A cover is configured to cover the sub-floor storage area of a vehicle and defines at least part of a load floor over the sub-floor storage area. Guides are secured to the vehicle body and define paths configured to guide movement of the cover between: a closed position in which the cover extends over the sub-floor storage area; an extended position in which the cover remains engaged with the guides and extends outward from the vehicle body; and an open position in which the cover is pivoted upwardly relative to the closed position. The guides may be grooves formed in the vehicle body and followers secure to the cover and are configured to engage the guides, such as rollers or slides. The guides may each include a first portion defining a path to the extended position, a second portion in which the followers seat when in the closed position.

### RELATED APPLICATION

This application claims the benefit of U.S. Application Ser. No. 63/559,086 filed Feb. 28, 2024, and entitled EXTENDABLE SUB-FLOOR STORAGE COVER.

### INTRODUCTION

The present disclosure relates to a cover for a sub-floor storage volume of a vehicle.

### SUMMARY

The present disclosure describes an approach for implementing a cover for sub-floor storage. In one aspect, a vehicle body defines a sub-floor storage area. A cover is configured to cover the sub-floor storage area and defines at least part of a load floor over the sub-floor storage area. Guides are secured to the vehicle body and define paths configured to guide movement of the cover between: a closed position in which the cover extends over the sub-floor storage area; an extended position in which the cover remains engaged with the guides and extends outward from the vehicle body; and an open position in which the cover is pivoted upwardly relative to the closed position.

### BRIEF DESCRIPTION OF THE DRAWINGS

FIG. 1A illustrates an example vehicle that may be used in accordance with certain embodiments.

FIG. 1B illustrates a chassis of a vehicle having multiple drive units that may be used in accordance with certain embodiments.

FIG. 2A is an isometric view of a sub-floor storage cover in a closed position in accordance with certain embodiments.

FIG. 2B is a cross-sectional side view of the sub-floor storage cover in a closed position in accordance with certain embodiments.

FIG. 3 is a side view of a guide for facilitating opening and extending of the sub-floor storage cover in accordance with certain embodiments.

FIG. 4 is an isometric view of a roller within the guide in accordance with certain embodiments.

FIG. 5 is a cross-sectional side view illustrating a process for extending the sub-floor storage cover in accordance with certain embodiments.

FIG. 6A is an isometric view illustrating the sub-floor storage cover in an extended position in accordance with certain embodiments.

FIG. 6B is a cross-sectional side view of the sub-floor storage cover in the extended position in accordance with certain embodiments.

FIG. 7A is an isometric view illustrating the sub-floor storage cover in an open position in accordance with certain embodiments.

FIG. 7B is a cross-sectional side view of the sub-floor storage cover in the open position in accordance with certain embodiments.

FIG. 8A is a side view illustrating the guide with integrated retention features in accordance with certain embodiments.

FIG. 8B is a top view illustrating an alternative retention feature in accordance with certain embodiments.

FIG. 9A is a cross-sectional side view illustrating nesting of the sub-floor storage cover on a scuff plate in accordance with certain embodiments.

FIG. 9B is a cross-sectional side view illustrating a retention feature for retaining the sub-floor storage cover relative to the scuff plate in accordance with certain embodiments.

FIG. 9C is an isometric view illustrating placement of retention features according to FIG. 9B in accordance with certain embodiments.

FIG. 10A is a side view illustrating a roller for facilitating sliding in accordance with certain embodiments.

FIG. 10B is a top cross-sectional view showing the roller of FIG. 10A.

### DETAILED DESCRIPTION

A vehicle defines sub-floor storage. A cover is positionable over the sub-floor storage and forms at least part of a load floor of the vehicle. Guides are secured to the vehicle, such as to sidewalls of the sub-floor storage. The guides engage followers secured to the cover and guide the cover between closed, extended, and open positions, such as: a closed position in which the cover extends over the sub-floor storage area; an extended position in which the cover remains engaged with the guides and extends outward from the vehicle body; and an open position in which the cover is pivoted upwardly relative to the closed position.

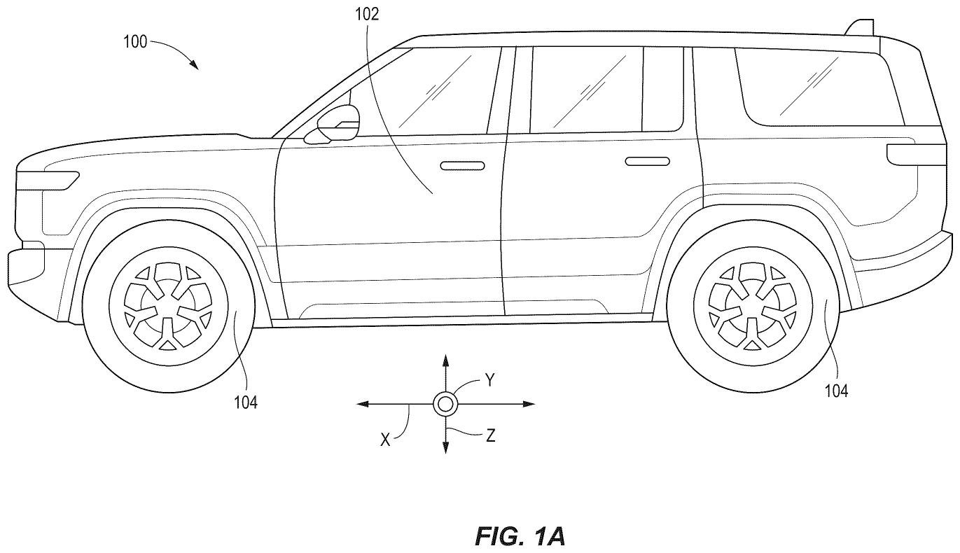

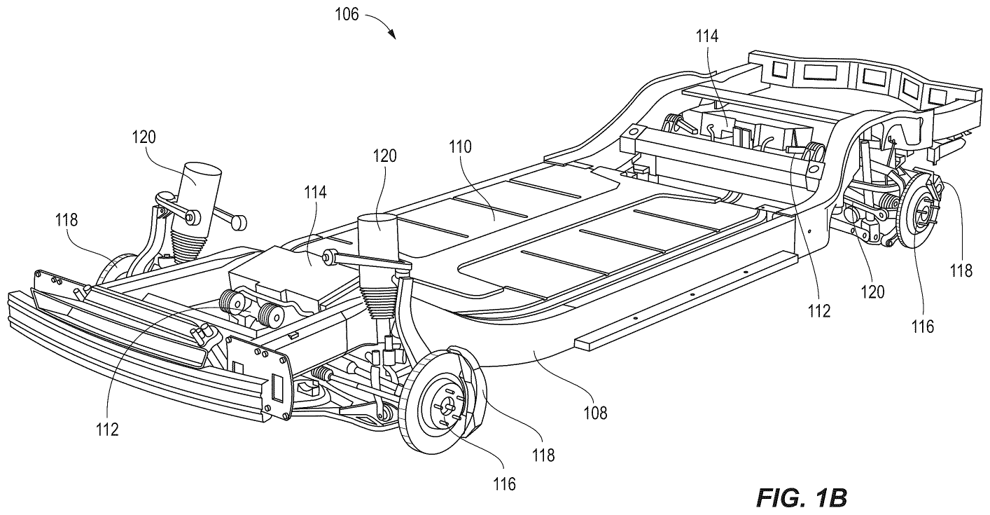

FIG. 1A illustrates an example vehicle 100 in which the approach described herein may be implemented. As seen in FIG. 1A, the vehicle 100 has a body 102 defining a passenger cabin and internal cargo area of the vehicle 100. The body 102 may be configured as a sport utility vehicle (SUV), pickup truck including external bed, or other type of vehicle. The vehicle 100 further includes a plurality of road wheels 104, such as four, that are driven to propel the vehicle 100 over a surface.

The vehicle 100 may be understood with respect to X, Y, and Z directions. The Z direction may correspond to the direction of gravity when the vehicle 100 is on a flat, level surface perpendicular to the direction of gravity. The X direction may correspond to the direction of the vehicle 100 when traveling in a straight line. The Y direction may be defined as perpendicular to the X and Z directions.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (e.g., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114, such as power electronics for each drive unit 112 or pair of drive units 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels 104 may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B, the vehicle 100 is a battery electric vehicle. However, a hybrid-electric vehicle or internal combustion engine vehicle may also benefit from the approach described herein. In particular, the vehicle 100 may be any vehicle having an internal or external storage area.

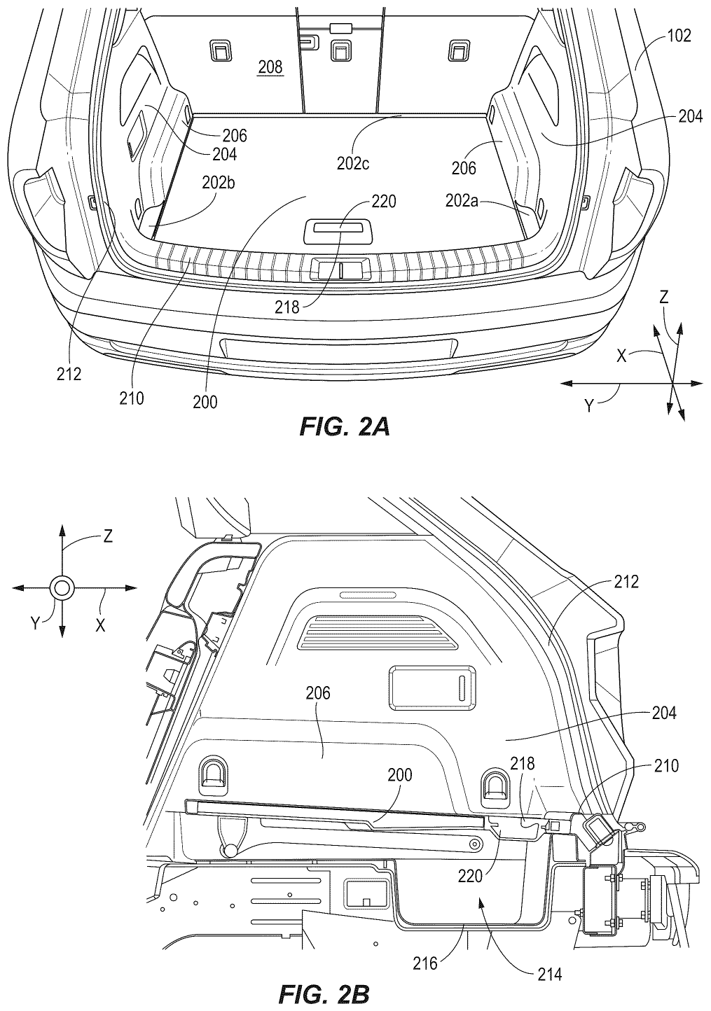

FIGS. 2A and 2B illustrate a sub-floor storage cover 200 (hereinafter “cover 200”) for use in a cargo area or other area of a vehicle. The cover 200 may define a substantially (e.g., within 2 centimeters of) planar surface, and the substantially planar surface may have a substantially rectangular shape (e.g., within 5 centimeters of a rectangular shape). The cover 200 may seat within a load floor of a vehicle. The load floor may be a generally (e.g., within 4 centimeters of) planar surface that is substantially (e.g., within 10 degrees of) parallel to the Y and X directions. The load floor may be the exposed bed of a pickup truck or an enclosed floor of a passenger or cargo vehicle. In some embodiments, such as that illustrated in FIGS. 2A and 2B, the cover 200 forms substantially all (e.g., at least 80, 90, or 95 percent) of the load floor. However, areas 202a, 202b, 202c around the cover 200 may also form part of the load floor. In the Y direction, the load floor may extend between one or both of internal side walls 204 and internal wheel well covers 206. In the X direction, the load floor may extend between seats 208 and lip 210, such as a scuff plate or other rearwardly positioned portion of the vehicle body 102. The load surface may be positioned below the lip 210 along the Z direction, such as between 5 and 25 centimeters below the lip 210.

The load floor may be accessible through an opening 212 or be exposed as in the case of a pickup truck bed. In some embodiments, the lip 210 forms a lower edge of the opening 212. The opening 212 may be covered by a liftgate hinged at the top of the opening 212, a tailgate hinged at the bottom of the opening 212, or door hinged at one or both sides of the opening 212.

As shown in FIG. 2B, the cover 200 covers a sub-floor storage area 214. The sub-floor storage area 214 may be available for storing cargo and may additionally or alternatively store equipment such as a spare tire, tire repair kit, tools, vehicle accessories, or the like. The sub-floor storage area 214 may have a volume of at least 20, 40, or 60 liters. In the illustrated embodiment, the sub-floor storage area 214 may be defined by the cover 200 and a sub-floor 216 formed by a lower body panel of the body 102 or other component of the vehicle 100.

The cover 200 may include a handle 218 to facilitate moving the cover 200 between the closed position shown in FIGS. 2A and 2B and extended and open positions as discussed below. The handle 218 may be positioned within a recess 220 defined by the cover 200. For example, the handle 218 and recess 220 may be formed in the cover 200 during formation of the cover 200 by molding or other process. The handle 218 may be positioned flush with or below the upper surface of the cover 200 when the cover is in the closed position.

The cover 200 may be made of a plastic such as acrylonitrile butadiene styrene (ABS), polypropylene, nylon, polyvinyl chloride (PVC), or other elastomer. The plastic may include glass fill, such as between 10 and 50 percent. The cover 200 may also be made of a composite material, such as fiberglass, carbon fiber, or KEVLAR composite material. The cover 200 may include stiffening elements, such as ribs formed thereon and/or therein (e.g., an internal honeycomb structure) to resist bending and failure of the cover 200 under load.

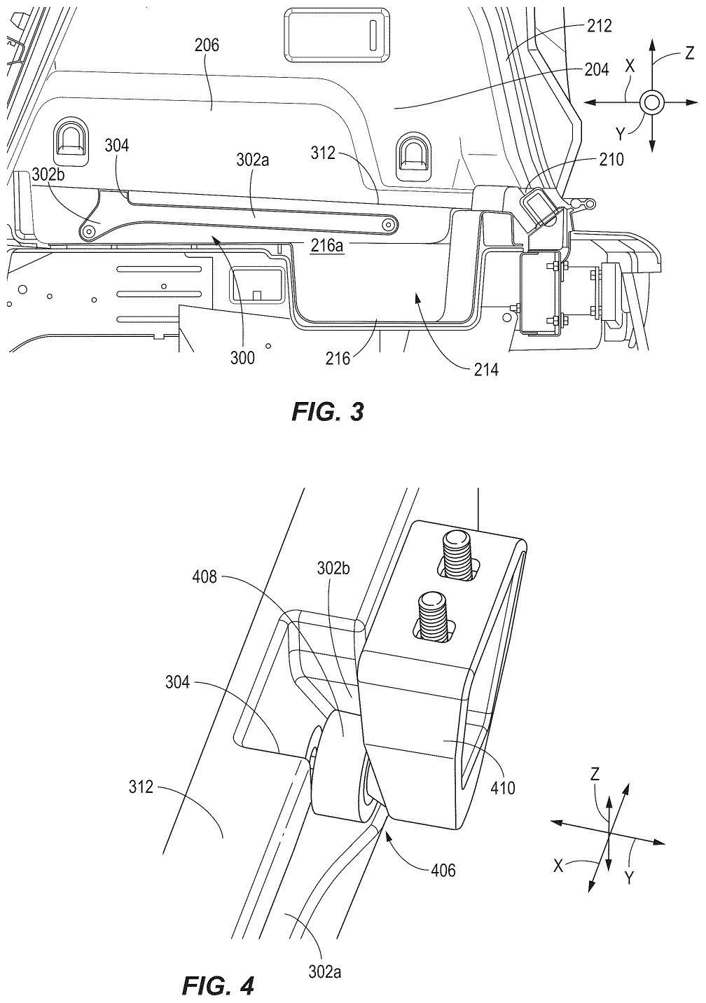

Referring to FIGS. 3 and 4, movement of the cover 200 between the closed, extended, and open positions may be facilitated by a guide 300. The guide 300 may be a groove secured by fasteners to a sidewall 216a extending upwardly from the sub-floor 216. The guide may be secured to the sidewall 216a due to being formed therein, such as by molding. The guide 300 may alternatively be implemented as a rail secured to or formed on the sidewall 216a. The guide 300 may have multiple portions 302a, 302b. A first portion 302a guides the cover 200 between the closed position and the extended position. The second portion 302b guides the cover 200 between the closed position and an open position and between the closed position and the extended position. The guide 300 may define an inlet 304 at a junction between the first and second portions 302a, 302b.

The guide 300 may be engaged by a follower 406. The follower 406 is substantially constrained to follow the first and second portions 302a, 302b. As used herein “substantially constrained” may be understood to mean constrained to remain within 3, 2, or 1 centimeters from a path defined by the first and second portions 302a, 302b. The follower 406 may be embodied as the illustrated roller 408 inserting into a guide 300 embodied as a groove. In other embodiments, the follower 406 may be implemented as a protrusion made of or coated with a smooth polymer such as nylon, TEFLON, ultra-high molecular weight (UHMW), or other low-friction material. The follower 406 may be a smooth protrusion inserting into the groove. Where the guide 300 is a rail, the follower 406 may be a pair of wheels on either side of the rail (e.g., along the Z direction), a pair of protrusions positioned on either side of the rail, or other type of follower. The follower 406 may be secured to the cover 200 by a bracket 410. The bracket 410 may be secured to the cover 200 by fasteners or by co-molding with the cover 200. In some embodiments, the follower, bracket 410, and cover 200 are formed monolithically, such as by co-molding.

The portion 302a may substantially constrain the follower 406 to traverse a straight path substantially (e.g., within 15 degrees of) parallel to the X direction. As is apparent in FIG. 3, the portion 302a may alternatively slope downwardly with proximity to the opening 212 along the X direction. For example, the portion 302a may slope downwardly at an angle of between 5 and 20 degrees. The angle of the portion 302a may be substantially (e.g., within 1 degree of) identical to an angle of the load floor in the plane defined by the X and Z directions.

The portion 302b may substantially constrain the follower 406 to traverse a path at a substantial angle relative to the X direction in a plane defined by the X and Z directions, such as an angle of between 30 and 60 degrees, such as between 40 and 50 degrees, such as between 43 and 47 degrees. The path defined by the portion 302b may slope downwardly with distance from the inlet 304, e.g., with distance away from the opening 212.

The inlet 304 may be positioned at a junction between the portion 302a, 302b and may be wider than the portion 302a, e.g., wider in the X direction than a width of the portion 302a in the Z direction. The widened inlet 304 may therefore facilitate insertion and removal of the follower 406.

In the illustrated embodiment, the portion 302a is much longer than the portion 302b. For example, the portion 302b may be no longer, or only slightly (e.g., less than 2 centimeters) longer than required to provide clearance for the follower 406 when the cover 200 is in the closed position. In contrast, the portion 302a may have a length that is between 0.5 and 0.8 times the length of the cover 200 in the plane defined by the X and Z directions when the cover 200 is in the closed position. The length of the portion 302a may define the extent that the cover 200 may be extended when in the extended position as described below.

The portion 302b may have a tapered shape that narrows with distance from the inlet 304. The tapered shape may facilitate a range of motion of the follower 406 in the plane defined by the Y and X directions when inserted into the inlet 304 and into the portion 302b. The tapered shape may further facilitate movement of the follower 406 when the cover 200 is pivoted into the open position as described in greater detail below.

FIGS. 3 and 4 further illustrate a shelf 312 that may support the cover 200 when in the closed position. The shelf 312 may be offset from and substantially (e.g., within 2 degrees of) parallel to the load floor, such as areas 202a, 202b, 202c of the load floor. The offset from the load floor may be substantially (e.g., within 5, 2, or 1 millimeters) equal to a thickness of the cover 200, e.g., a portion of the cover 200 that rests on the shelf 312 when the cover 200 is in the closed position. The shelf 312 may be defined by the sidewall 216a of the sub-floor 216, such as by molding into the sidewall 216a. The width of the shelf 312 in the Y direction may be selected to provide adequate support to the cover 200. For example, for a maximum load (e.g., 200, 300, or 400 Newtons or more), the width of the shelf 312 may be selected such that the cover 200 will not slip off the shelf 312 due to bending of the cover 200. In some embodiments, the inlet 304 extends to the shelf 312 and forms a gap between portions of the shelf 312 on either side of the inlet 304.

The illustrated guide 300 and follower 406 of FIGS. 3 and 4 are shown for the right side of the storage area 214. A corresponding guide 300 and follower 406 are also positioned on the left side of the storage area 214 in a mirrored configuration, e.g., mirrored about the plane defined by the Y and Z directions.

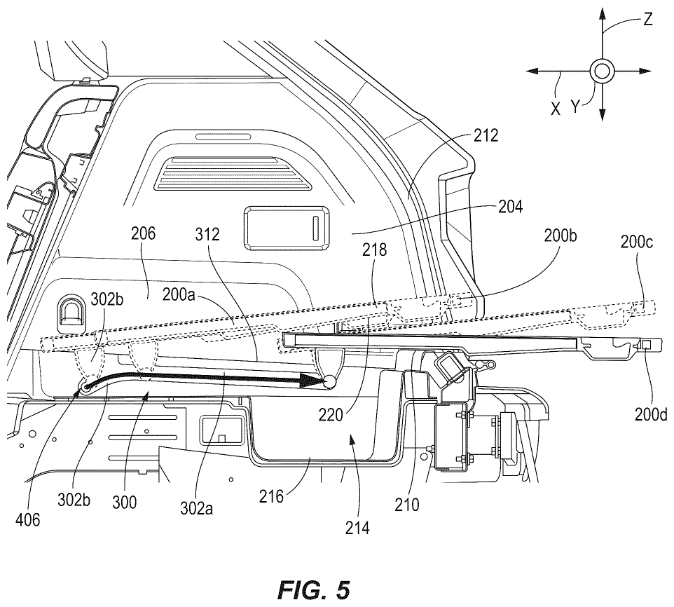

FIG. 5 illustrates an example process of moving the cover 200 from the closed position to the extended position. From the closed position, the user grasps the handle 218 and lifts upward, e.g., at least a component of exerted force upward along the Z direction. The cover 200 will move upward to position 200a. The user pulls the cover 200 to a height such that the rearward end of the cover 200 is positioned above the lip 210 as shown by position 200b. The user then pulls the cover 200 rearwardly, e.g., at least a component of force exerted rearward along the X direction. The follower 406 will then slide out of the portion 302b, past the inlet 304, and into the portion 302a. The follower 406 will continue to follow the portion 302a until the follower 406 reaches the rearward end of the portion 302a as shown by position 200c. The user may then lower the cover 200 to rest on the lip 210, as shown by position 200d, e.g., the extended position. In some embodiments, the cover 200 may be rested on the lip 210 at an intermediate position between the extended position and the closed position.

Transitioning the cover 200 back to the closed position may be performed by performing the reverse of the process of transitioning from the closed position to the extended position. The user lifts the cover 200 off the lip 210, slides the cover 200 and follower 406 rearward until the follower 406 seats within the portion 302b, and then lowers the cover 200, such as onto the shelf 312. In some embodiments, one or more of the steps performed by a user as outlined above with reference to FIG. 5 may be performed by powered electronics, e.g., motors or other actuators. For example, the followers 406 may engage actuators that induce movement of the followers 406 within the portion 302a, the portion 302b, or both. Likewise, pivoting of the cover 200 may be induced by one or more actuators. Interface elements for controlling actuation of the cover 200 may be mounted to the sidewall 204, for example, or displayed on a touch screen.

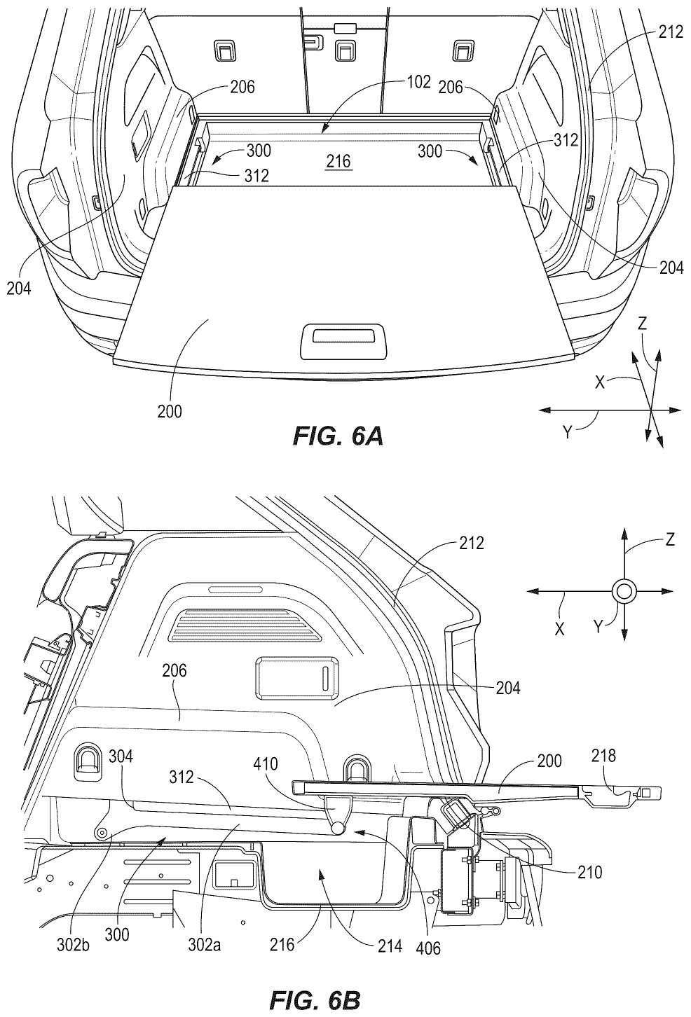

FIGS. 6A and 6B illustrate the cover 200 in the extended position. In the extended position, the cover 200 extends outwardly from the lip 210 (e.g., rearwardly in the X direction) and may extend outwardly from the vehicle body 102 in the plane defined by the Y and X directions. Rotation of the cover 200 in at least one direction is limited by engagement of the follower 406 with the guide 300 and support of the cover 200 by the lip 210. For example, counterclockwise rotation (e.g., about an axis parallel to the Y direction) is prevented in the orientation shown in FIG. 6B.

In the extended position, the cover 200 may be available to perform various functions such as:
A seat for a person.
A table for serving or preparing food.
A platform for loading items that can then subsequently be slid into the vehicle 100 in a reverse of the process shown in FIG. 5.

Furthermore, in the extended position, at least a portion of the storage area 214 may be accessible for removing items from the storage area 214 or loading items into the storage area 214.

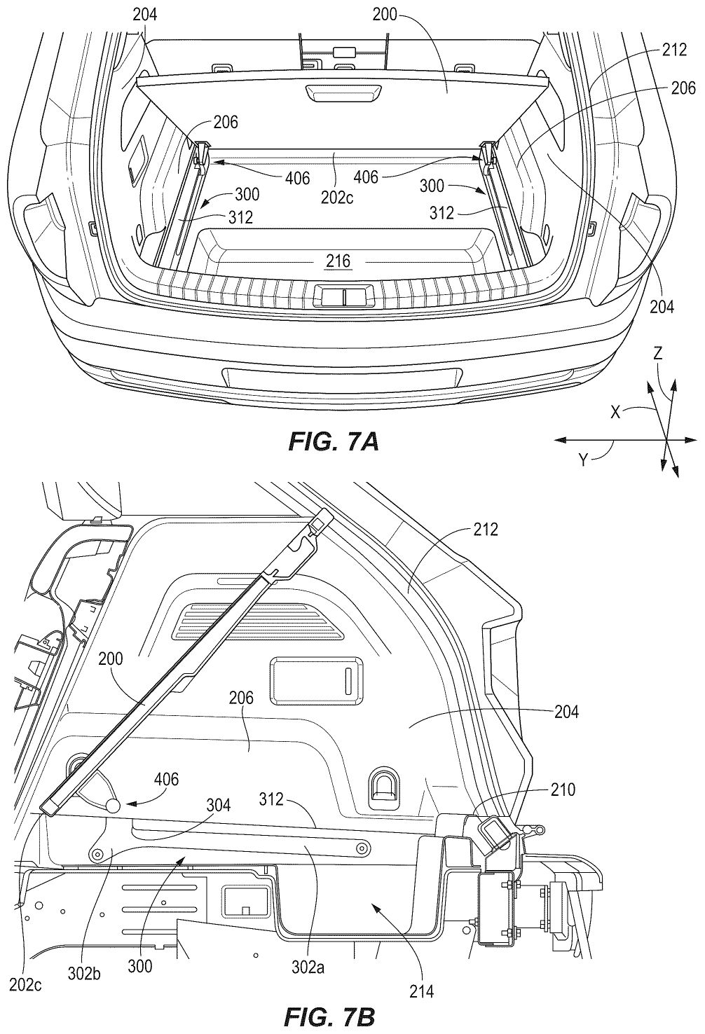

FIGS. 7A and 7B illustrate the cover 200 in the open position. To transition the cover 200 from the closed position to the open position, a user grasps the handle 218 and lifts upwardly, e.g., at least a portion of force exerted along the Z direction. The cover 200 may pivot (e.g., counterclockwise about an axis parallel to the Y direction) such that the follower 406 pivots within the portion 302b toward the inlet 304 and possibly exits the inlet 304. In the open position, a forward edge of the cover 200 may rest on the load floor, such as area 202c, or on the shelf 312 or other structure on or around the load floor. When in the open position, the storage area 214 is accessible for inserting or removing items. From the open position, a user may also remove the cover 200 entirely.

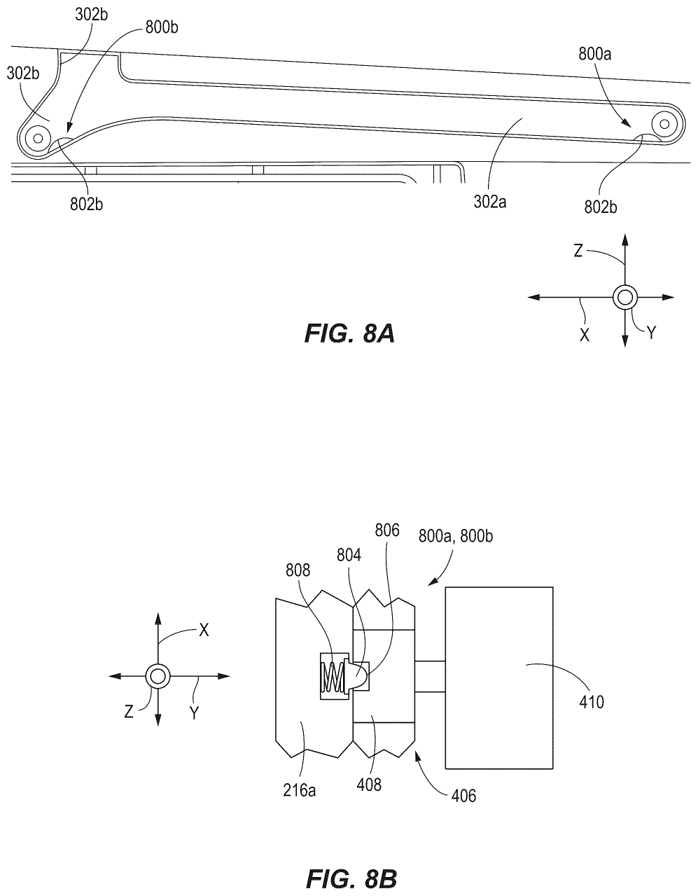

Referring to FIGS. 8A and 8B, in some embodiments, structures may be used to retain the cover 200 in the closed or extended positions. A retention feature 800a may be positioned at or near a position of the follower 406 when the cover 200 is in the extended position and a retention feature 800b may be positioned at or near a position of the follower 406 when the cover 200 is in the closed position. For example, the follower 406 may be required to move past retention feature 800a to move into and out of the extended position and be required to move past the retention feature 800b to move into and out of the closed position. In some embodiments, the retention features 800a, 800b may impose a requirement for force to be exerted to move the follower 406 out of the extended and closed positions, respectively. In some embodiments, the retention features 800a, 800b may impose a requirement for force to be exerted to move the follower 406 more than a predetermined distance from the extended and closed positions, respectively. For example, the retention features 800a, 800b may permit 0, 1, 2, or more centimeters of movement away from the extended and closed positions, respectively, before engaging the followers 406. The retention features 800a, 800b may require a force of at least 20, 30, 40, or more Newtons to move the follower 406 past the retention features 800a, 800b.

Referring specifically to FIG. 8A, the retention features 800a, 800b may be implemented as protrusions 802a, 802b extending into the portions 302a, 302b that require deformation or deflection of the protrusions 802a, 802b and/or follower 406 to move past the retention features 800a, 800b.

Referring specifically to FIG. 8B, the retention features 800a, 800b may be implemented as a spring-loaded detent 804. For example, the follower 406 may define an indentation 806. The detent 804 may be mounted within the guide 300 with the detent sliding in the Y direction. The detent 804 may be positioned to be urged into the indentation 806 by a spring 808 when the follower 406 is in the extended position (retention feature 800a) or the closed position (retention feature 800b). The detent 804 will slide out of the indentation 806 when the follower 406 is urged out of the extended position or closed position with sufficient force to overcome the biasing force of the spring 808.

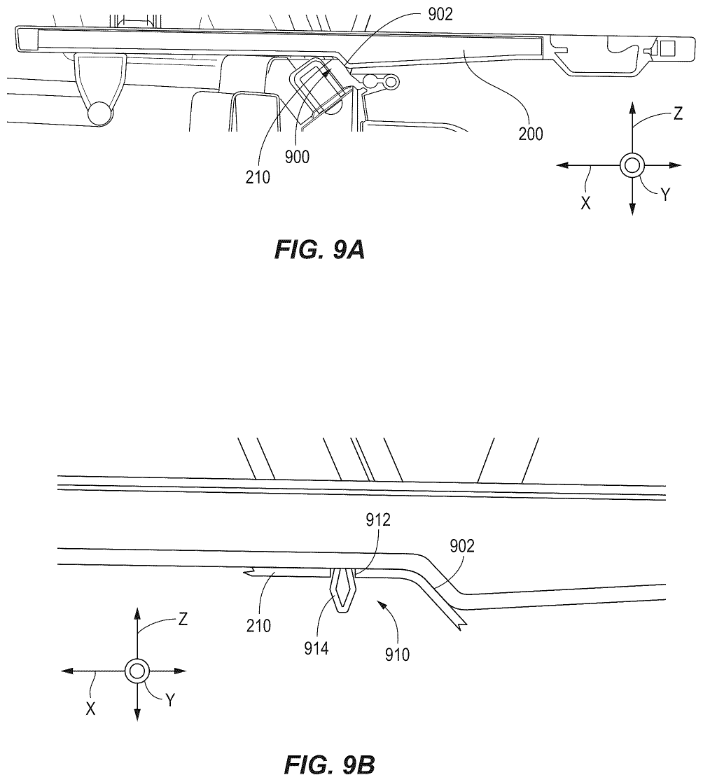

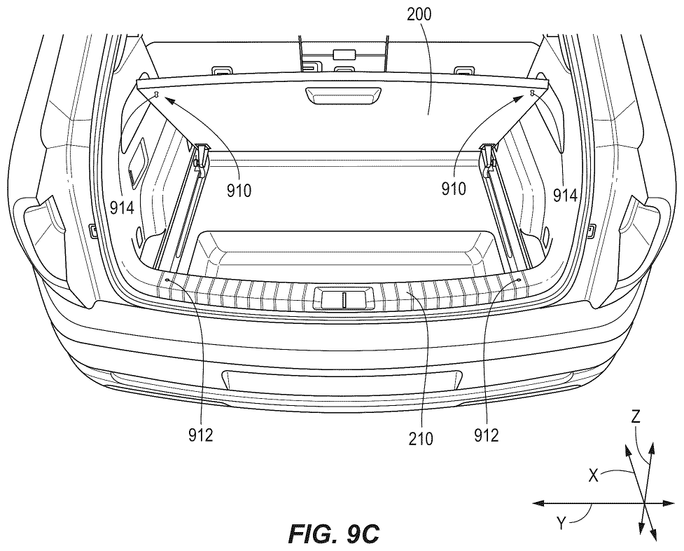

Referring to FIGS. 9A, 9B, and 9C, in some embodiments, one or more features may be present to retain the cover 200 when in the extended position. In particular, one or more features may be present to hinder the cover 200 from moving from the extended position partially or completely toward the closed position.

Referring specifically to FIG. 9A, the cover 200 may include a seat 900 sized, shaped, and configured to engage the lip 210. For example, the seat 900 may include a surface 902 that faces, at least partially, along an axis parallel to the Y direction in a forward direction, e.g., in the direction that the cover 200 moves when transitioning from the extended position to the closed position. Stated differently, normal vectors along a major portion of the surface 902 have a component pointing along the Y direction in the direction moved by the cover 200 when transitioning from the extended position to the closed position (e.g., the forward direction). The normal vectors may further have a component downward along the X direction. For example, the normal vectors may define an angle of between −30 and −90 degrees relative to the X direction in the plane defined by the X and Z directions.

In the illustrated embodiment, the surface 902 is straight in the plane defined by the X and Z directions. In other embodiments, the surface 902 may be curved. The surface 902 may be curved in the plane defined by the X and Y directions to conform to curvature of the lip 210 at the bottom of the opening 212.

Referring specifically to FIGS. 9B and 9C, in some embodiments, a retention feature 910 may releasably secure the cover 200 to the lip 210 either alone or in combination with the surface 902. For example, the lip 210 may define an opening 912, and a retention clip 914 may be secured to the cover 200, such as a downward facing surface of the cover. The retention clip 914 may be positioned to be insertable within the opening 912 when the cover 200 is in the extended position. The retention clip 914 may be made of metal or plastic. In the absence of a deforming force, at least a portion of the retention clip 914 may be larger than the opening 912. Accordingly, deformation of the retention clip 914 may be required to insert the retention clip 914 into the opening 912 with biasing force exerted by the retention clip 914 resisting removal from the opening 912. In particular, the retention clip 914 may resist raising of the cover 200 from the lip 210 along the Z direction as well as sliding of the cover 200 in the X direction from the extended position toward the closed position. As shown in FIG. 9C, there may be two openings 912 and retention clips 914 offset from one another in the Y direction, such as by at least 40, 60, or 80 percent of a width of the cover 200 in the Y direction.

The retention clips 914 and the openings 912 may cooperate with the surface 902 to resist transitioning of the cover 200 from the extended position toward the closed position: the cover 200 must be raised upwardly in the Z direction to disengage the surface 902 from the lip 210, and the retention clips 914 resists this upward movement.

In some embodiments, the retention clips 914 may be substituted for pins or other structures that insert within the openings 912 and resist translation from the extended position toward the closed position along the X direction, but do not resist removal form the openings 912. In some embodiments, the retention clips 914 may engage openings formed on the shelf 312 or other structure to retain the cover 200 in the closed position.

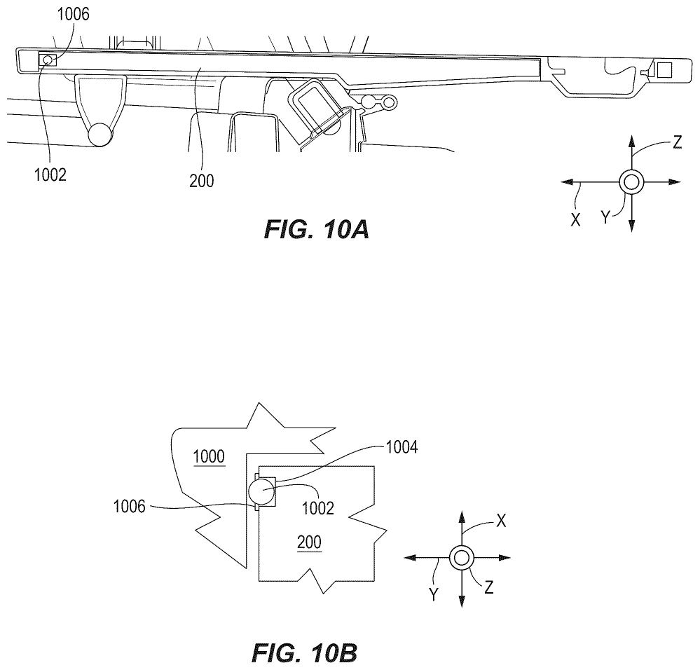

Referring to FIGS. 10A and 10B, a gap may be present between sides of the cover 200 and interior panels 1000 of the vehicle 100, e.g., the wheel well covers 206 and/or sidewalls 204 in the illustrated embodiment. The gap may be present along the Y direction to permit sliding of the cover 200 relative to the interior panels 1000 in the X direction. However, such a gap permits some rotation of the cover 200 about an axis that is substantially (e.g., within 10 degrees of) parallel to the Z direction. Such rotation can result in binding of corners of the cover 200 relative to the interior panels 1000. In some embodiments, rollers 1002 may be secured at or near front corners of the cover 200. As used herein “front corner” may be characterized as an intersection of a front edge of the cover 200 extending substantially (e.g., within two degrees) in the Y direction with a side edge of the cover 200 extending substantially (e.g., within two degrees) in the X direction, the front edge being closer to the front of the vehicle 100 when cover 200 is in the closed position than an opposite edge of the cover 200 that also extends substantially in the Y direction (“the rear edge”). As used herein a “front corner” may include a rounded transition between the front edge and the side edge. As used herein “at or near” may be understood as (a) a distance between the roller 1002 and the front edge being 1 D or less, where D is the diameter of the roller 1002, (b) within 5, 3, or 1 percent of a distance between the front edge and the rear edge, (c) within N*X of the front edge, where N is 3, 2, or 1, and X is a size of the gap between the side edge and the interior panel 1000 interfacing with the side edge assuming the cover 200 is centered between the interior panels 1000 on either side of the cover 200.

As shown in FIG. 10B, the roller 1002 may seat within a pocket 1004 formed by the cover 200 or secured thereto. The roller 1002 may be a spherical roller or a cylindrical roller with an axis of rotation substantially (e.g., within 2 degrees of) parallel to the Z direction. The roller 1002 may be held in place by a cover plate 1006 through which a portion of the roller 1002 protrudes, an axle of the roller 1002 being secured to the cover 200, or other retainer. The roller 1002 may be biased outwardly such that pressure on the roller 1002 to retract partially into the pocket 1004. In other embodiments, contact with the interior panel of the vehicle is not necessarily maintained such that biasing is not present.

FIGS. 10A and 10B show the left side of the vehicle 100 with the understanding that the right side may be in a mirrored configuration with a corresponding roller 1002 engaging the corresponding interior panel on the right side of the cover 200.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. A vehicle comprising:
a vehicle body defining a sub-floor storage area;
a cover configured to cover the sub-floor storage area and defining at least part of a load floor over the sub-floor storage area; and
guides secured to the vehicle body and defining paths configured to guide movement of the cover between:
a closed position in which the cover extends over the sub-floor storage area;
an extended position in which the cover remains engaged with the guides and extends outward from the vehicle body; and
an open position in which the cover is pivoted upwardly relative to the closed position.

2. The vehicle of claim 1, wherein the guides include grooves, the cover having followers secured thereto and configured to engage the grooves.

3. The vehicle of claim 2, wherein the followers include at least one of rollers or sliders.

4. The vehicle of claim 2, wherein the guides include first portions configured to guide the followers to the extended position and second portions configured to receive the followers when in the closed position.

5. The vehicle of claim 4, wherein the guides define inlets permitting insertion of the followers into the guides.

6. The vehicle of claim 5, wherein the inlets are at junctions of the first portions and the second portions.

7. The vehicle of claim 1, wherein:
the guides are molded into sidewalls of the sub-floor storage area; and
rollers are mounted to right and left sides of the cover at a forward edge of the cover and configured to engage the sidewalls responsive to twisting of the cover relative to the sidewalls.

8. The vehicle of claim 1, wherein the vehicle body includes one or more areas defining the load floor with the cover, the cover positioned substantially flush with the one or more areas when in the closed position.

9. The vehicle of claim 1, wherein sidewalls of the sub-floor storage area define shelves for supporting the cover when in the closed position.

10. The vehicle of claim 1, further comprising retention features configured to resist movement of the cover out of at least one of the closed position or the extended position.

11. The vehicle of claim 1, wherein the vehicle body defines a lip along the load floor, the cover configured to rest on the lip when in the extended position.

12. The vehicle of claim 11, wherein the cover defines a seat configured to engage the lip and resist movement from the extended position toward the closed position when the cover is in the extended position.

13. The vehicle of claim 11, wherein the cover has one or more retention features secured thereto and configured to releasably secure the cover to the lip.

14. The vehicle of claim 1, wherein the cover defines a recess and a handle positioned in the recess.

15. A vehicle component comprising:
a cover configured to cover a sub-floor storage area defined by a vehicle body;
a first follower extending from a first side of the cover and configured to engage a first guide secured to a sidewall of the sub-floor storage area; and
a second follower extending from a first side of the cover and configured to engage a second guide secured to a sidewall of the sub-floor storage area.

16. The vehicle component of claim 15, wherein the first and second followers each include a roller.

17. The vehicle component of claim 15, wherein the first follower is secured to the cover by a first bracket, and the second follower is secured to the cover by a second bracket.

18. The vehicle component of claim 15, wherein the cover defines a recess, and a handle is positioned within the recess.

19. A method comprising:
moving a cover from a closed position to an extended position, the cover being positioned over a sub-floor storage area defined by a vehicle body when in the closed position and extending outwardly from the vehicle body when in the extended position;
wherein moving the cover from the closed position to the extended position comprises pivoting the cover from the closed position and sliding the cover to the extended position.

20. The method of claim 19, further comprising:
starting with the cover in the closed position, pivoting the cover upwardly into an open position in which the sub-floor storage area is accessible.
